(19) United States
(12) Patent Application Publication
(10) Pub. No.: US 2010/0119368 A1
(43) Pub. Date: May 13, 2010

(54) DOUBLE SEAL WITH PRESSURISED LIP

(75) Inventors: Monique Janette Alice Fos, Rontignon (FR); Franck Labarthe, Baudreix (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Turbomeca, Bordes (FR)

(21) Appl. No.: 12/593,094

(22) PCT Filed: Mar. 27, 2008
(86) PCT No.: PCT/FR08/50532

§ 371 Date: Jan. 14, 2010

(30) Foreign Application Priority Data
Mar. 27, 2007 (FR) 0754050

(51) Int. Cl. F02C 7/28; F16J 15/32

(52) U.S. Cl. 415/230; 277/562

(57) ABSTRACT

A sealing device for providing sealing between a casing and a shaft rotatably mounted in the casing. The device includes first and second annular lip gaskets for placing axially side by side between the casing and the shaft. A stream of pressurized gas is delivered into an annular casing defined by the first lip gasket, the second lip gasket, and an outside surface of the shaft, such that during rotation of the shaft, the gas stream is suitable for causing at least one of the two lip gaskets to lift off a little from the outside surface of the shaft in order to flow out from the cavity.

The present invention relates to the field of sealing gaskets, in particular radial-friction gaskets.

More particularly, the present invention relates to a sealing device for providing sealing between a casing and a shaft rotatably mounted in said casing, the device comprising first and second annular lip gaskets for placing axially side by side between the casing and the shaft.

Below, the adjectives “axial” and “radial” are relative to the direction of the axis of rotation of the shaft.

Traditionally, a pair of lip gaskets is used to provide an enclosure with sealing by making contact with the shaft.

Because of the friction that exists between the shaft and the lips of the gasket, rotation of the shaft gives rise to wear of the lip gaskets and requires the gaskets to be changed, in particular to avoid leaks of oil.

Such leaks of oil are harmful to the environment and they may also lead to damage to rotary parts such as the gearwheels that are no longer properly lubricated.

When such a device is mounted in a helicopter turbine engine, the helicopter needs to be taken out of action in order to change the gaskets, which presents a cost that it is desirable to avoid.

An object of the present invention is to provide a sealing device having a lifetime that is longer than that of the prior art.

The invention achieves this object by the fact that the sealing device of the invention further includes means for delivering a stream of pressurized gas into an annular casing defined by the first lip gasket, the second lip gasket, and an outside surface of the shaft, such that during rotation of said shaft, the gas stream is suitable for causing at least one of the two lip gaskets to lift off a little from the outside surface of the shaft in order to flow out from the cavity, the means for delivering the pressurized gas stream further including a diaphragm for limiting the flow rate of the pressurized air in the event of one of the annular lip gaskets becoming damaged.

Thus, during rotation of the shaft, at least one of the two lip gaskets, and preferably both of them, lift(s) off from the outside surface of the shaft as a result of the gas stream flowing between the lip gaskets and the outside surface of the shaft, thereby advantageously eliminating friction between the shaft and the sealing device.

In spite of the lip gasket(s) lifting off, the sealing function is advantageously preserved by the gas stream flowing out from the cavity and tending to keep the external particles outside the cavity. It can thus be understood that particles of oil or dust cannot pass through the sealing device in one direction or the other.

As a result, the sealing device in accordance with the present invention wears substantially slower than does a prior art device, thereby having the effect of increasing its lifetime.

Furthermore, when the shaft is not rotating, sealing is achieved merely by the fact that the annular lip gaskets come into contact against the outside surface of the shaft. There is no need to pressurize the cavity at this time since there is no friction between the shaft and the sealing device.

Preferably, the diaphragm is placed in the channel or at one of its ends.

During normal operation of the sealing device of the invention, the flow rate of gas is limited by the lift-off distance of the lips of the lip gaskets.

Should one of the two lips become damaged, then the gas flow rate could increase suddenly giving rise to an undesirable loss of gas.

By virtue of the diaphragm, the flow rate of the gas is advantageously limited in the event of one of the lip gaskets being damaged.

Preferably, the first lip gasket includes a first lip, while the second lip gasket includes a second lip, and the first and second lips are designed to extend in the axial direction of the shaft while extending away from each other.

Thus, it is the first and second lips that lift off from the outside surface of the shaft when the gas stream flows out from the cavity.

Advantageously, the means for delivering the pressurized gas stream comprise a channel disposed between the first and second lip gaskets, said channel being connected to a source of pressurized gas.

Preferably, the channel extends radially between the two lip gaskets.

The present invention also provides to a helicopter turbine engine including a casing and a shaft rotatably mounted in said casing, said turbine engine further including a sealing device in accordance with the present invention.

Advantageously, the turbine engine of the invention further includes a source of pressurized gas for feeding the means for delivering a stream of pressurized gas to the annular cavity.

In preferred, but non-exclusive manner, the source of pressurized gas is a take-off located at the outlet from the compression stage.

It is also possible to provide an external source of pressurized gas without going beyond the ambit of the present invention.

The invention can be better understood and its advantages appear more clearly on reading the following description of an embodiment given by way of non-limiting example. The description refers to the accompanying figures, in which:

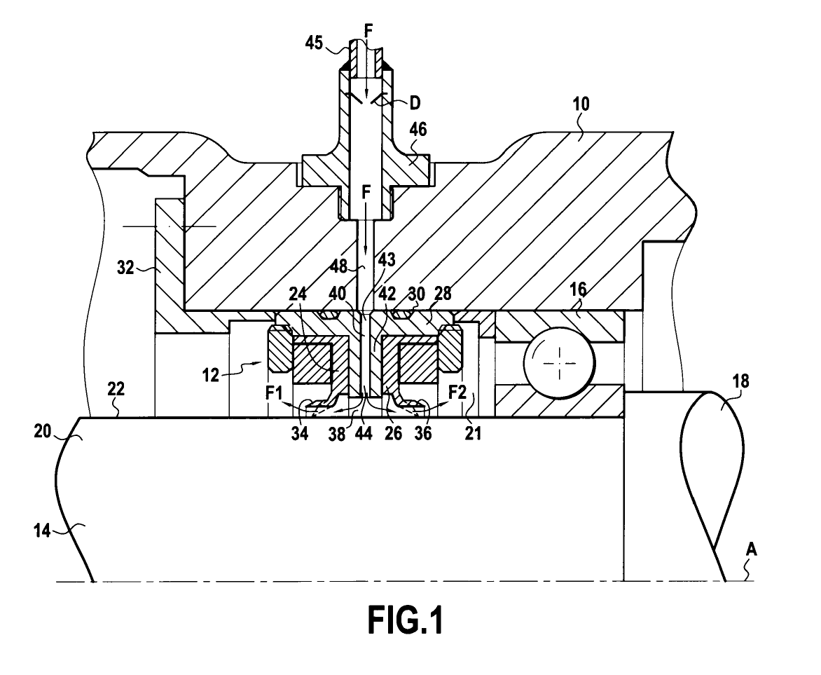

FIG. 1 is a detailed view of a helicopter turbine engine casing having a rotary shaft mounted therein, the turbine engine including a sealing device in accordance with the present invention; and

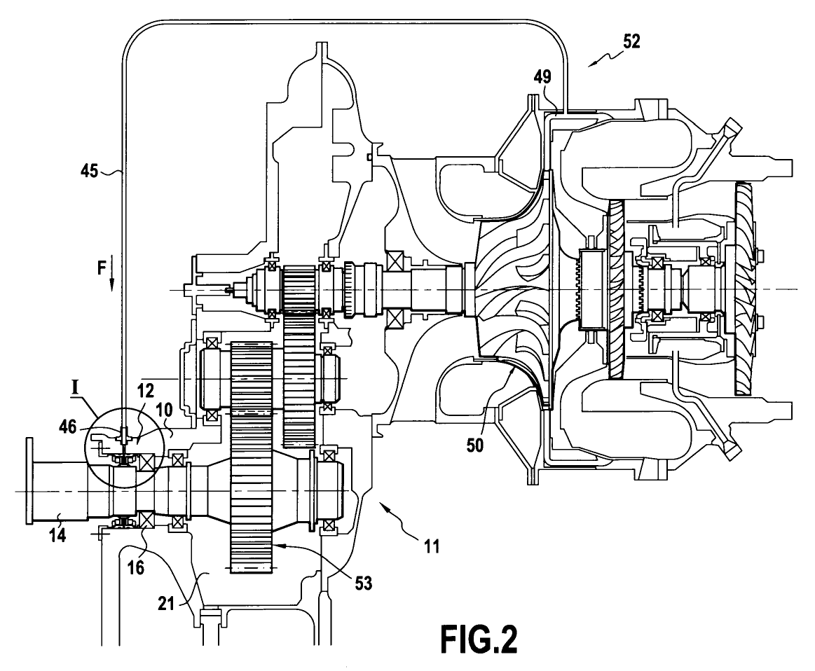

FIG. 2 shows a turbine engine provided with a sealing device of the present invention.

FIG. 1 shows a detail of a casing 10 of a reduction gear 11 of a turbine engine 52 for a flying vehicle such as a helicopter, the casing having a sealing device 12 in accordance with the invention mounted therein. Clearly this figure shows merely one non-limiting example of how the device of the invention can be used.

As can be seen in FIG. 1, a shaft 14 presents an axis of rotation A and is mounted to rotate in the casing 10, in particular by means of a bearing 16.

Specifically, the casing 10 corresponds to the casing of the reduction gear 11 of the turbine engine, i.e. the end 18 of the shaft 14 beside the bearing is designed to be coupled to gears, while the opposite end 20 is a power take-off for coupling to a shaft that transmits torque to the rotor of the helicopter.

In other words, the power take-off end 20 is situated outside the turbine engine 52, while the end 18 beside the enclosure 21 of the reduction gear 11 is situated inside the turbine engine 52.

In order to lubricate the rotary elements situated within the enclosure 21 of the reduction gear 11, oil is injected therein, such that this portion of the turbine engine 52 contains an air/oil atmosphere.

Both for environmental and for mechanical considerations, it is appropriate to prevent oil from escaping from the casing 10 of the reduction gear 11.

It is also appropriate to avoid dust or other undesirable particles penetrating into the enclosure 21 of the reduction gear 11, since otherwise there would be a risk of the gearwheels 53 of the reduction gear 11 being damaged.

In order to do this in accordance with the invention, the sealing device 12 placed between the casing 10 and the shaft 14 serves to prevent both loss of oil and penetration of external particles into the enclosure of the reduction gear 11, while also presenting a lifetime that is longer than a prior art sealing device.

For this purpose, the sealing device 12 comprises a first annular lip gasket 24 and a second annular lip gasket 26 that are disposed side by side between the casing 10 and the shaft 14 while also lying on a common axis, it being understood that their common axis corresponds substantially to the axis A of the shaft 14.

Preferably, the annular lip gaskets 24 and 26 are radial contact gaskets and they are preferably made of elastomer.

The first and second annular lip gaskets 24 and 26 are preferably fastened to a sleeve 28 placed axially in a bore 30 of the casing 10, the sleeve 28 itself being held securely to the casing 10 between an end plate 32 that is secured to the casing 10 and the bearing 16.

As can be seen in FIG. 1, the first and second annular lip gaskets 24 and 26 have respective first and second lips 34 and 36 that extend in the axial direction of the shaft 14 while also extending away from each other.

Furthermore, the lips 34 and 36 are shaped to present a first position, drawn in dashed lines in FIG. 1, in which each of them comes into contact with the outside surface 22 of the shaft 14 in order to provide sealing for the enclosure 21 of the reduction gear 11.

In accordance with the invention, the lips 34 and 36 are in their first position preferably while the shaft 14 is not rotating. In other words, in their first position, the lips 34 and 36 provide static sealing between the casing 10 and the shaft 14.

It will be understood that in their first position the first lips 34 prevent external particles from penetrating into the enclosure 21, while the second lip 36 prevents droplets of oil from escaping from the enclosure 21 of the reduction gear 11.

In particularly advantageous manner, the lips 34 and 36 are suitable for taking up a second position, drawn in continuous lines in the figure, in which position, the lips 34 and 36 lift off from the outside surface 22 of the shaft 24.

Preferably, the lips 34 and 36 take up their second position when the shaft 14 is rotating.

To do this, an annular cavity 38 defined by the first lip 34, the second lip 36, and the outside surface 22 of the shaft 14 is pressurized by means 40 for bringing a stream F of pressurized gas into said cavity 38.

Said means comprise a channel 40 formed in a rib 42 inside the sleeve 28, said rib 42 occupying a plane that is orthogonal to the axis A of the shaft 14 such that the channel 40 extends substantially radially.

With reference to FIG. 1, it can be seen that a first end 44 of the channel 40 opens out into the annular cavity 38, while a second end 43 of the channel 40, opposite from the first end 44, is connected to a coupling 46 via a radial pipe 48 provided in the casing 10.

The coupling 46 is connected via tubing 45 to a pressure source which, in the present example, is a take-off point 49 situated at the outlet from a compressor 50 of the turbine engine 52, as shown in FIG. 2.

In other words, the gas in this example corresponds to an air fraction taken from the air compressed by the compressor 50.

An advantage of using the outlet from the compressor 50 as a source of pressure is that it makes it possible to omit using an external pressure source, although that remains entirely possible within the ambit of the present invention.

In accordance with the invention, the gas stream F delivered to the cavity 38 is at a pressure that is sufficient to enable it to lift the lips 34 and 36 off from the outside surface 22 of the shaft 14.

It can thus be understood with the help of arrows shown in FIG. 1, that the gas stream F lifts the lips 34 and 36 off from the outside surface 22 of the shaft 14 so as to flow away from the cavity 38.

More precisely, the gas stream leaving the cavity 38 is preferably constituted by a first annular stream F1 flowing axially out from the turbine engine 52 and by a second annular stream F2 flowing axially towards the inside of the enclosure 21 in the opposite direction to the first annular stream F1.

It can thus be understood that by means of the invention, the first stream F1 prevents external particles from entering the enclosure 21 of the reduction gear 11, while the second stream F2 prevents oil droplets from escaping from the enclosure 21, with sealing thus being ensured in spite of the fact that the lips 34 and 36 are lifted off when they are in their second position.

As mentioned above, because of the lips 34 and 36 advantageously being lifted off the shaft 14 while it is rotating, the annular lip gaskets 24 and 26 wear substantially less since there is no friction while the shaft is rotating.

The sealing device of the invention thus presents a lifetime that is longer than in the prior art.

Advantageously, the sealing device of the present invention also includes a diaphragm D serving to limit the flow rate of pressurized gas in the event of one or the other of the lips 34 and 36 becoming damaged.

1-7. (canceled)

8. A sealing device for providing sealing between a casing and a shaft rotatably mounted in the casing, the device comprising:
first and second annular lip gaskets for placing axially side by side between the casing and the shaft;
means for delivering a stream of pressurized gas into an annular casing defined by the first lip gasket, the second lip gasket, and an outside surface of the shaft, such that during rotation of the shaft, the gas stream is suitable for causing at least one of the two lip gaskets to lift off a little from the outside surface of the shaft in order to flow out from the cavity, and
wherein the means for delivering the pressurized gas stream includes a diaphragm for limiting flow rate of the pressurized gas in the event of one of the annular lip gaskets becoming damaged.

9. A sealing device according to claim 8, wherein the first lip gasket includes a first lip while the second lip gasket includes a second lip, and wherein the first and second lips extend in the axial direction of the shaft while extending away from each other.

10. A sealing device according to claim 9, wherein the means for delivering the pressurized gas stream comprises a channel disposed between the first and second lip gaskets, the channel being connected to a source of pressurized gas.

11. A helicopter turbine engine including a casing and a shaft rotatably mounted in the casing, and a sealing device according to claim 9.

12. A helicopter turbine engine according to claim 11, further comprising a source of pressurized gas for feeding the means for delivering a pressurized gas stream into the annular cavity.

13. A helicopter turbine engine having a compression stage according to claim 12, wherein the source of pressurized gas is a take-off disposed at the outlet from the compression stage.

14. A turbine machine including a sealing device according to claim 8.
